(19) United States
(12) Patent Application Publication
(10) Pub. No.: US 2024/0303105 A1
(43) Pub. Date: Sep. 12, 2024

(54) Method and system for performing a digital process

(71) Applicant: EQT AB, STOCKHOLM (SE)

(72) Inventor: Pietro CASELLA, STOCKHOLM (SE)

(21) Appl. No.: 18/263,137

(22) PCT Filed: Feb. 4, 2022
(86) PCT No.: PCT/SE2022/050128

§ 371 Date: Jul. 27, 2023

(30) Foreign Application Priority Data
Feb. 4, 2021 (SE) 2150134-1

(51) Int. Cl. G06F 9/48; G06F 9/4401

(52) U.S. Cl. CPC G06F 9/4806; G06F 9/4411

(57) ABSTRACT

Method for performing a digital process (P). In the method, a central system initiates the process with a defined set of at least a second activity (A2) to be performed by a second, autonomous peripheral system (220). Further, the central system requests said second peripheral system to perform said second activity, the second peripheral system performs said second activity, and a resulting second piece of information (12) is made available to said central system. Then,

the central system updates a process status based on the second piece of information.

The invention is characterised in that a second request (R2) comprises a second identifier (ID2), in that said second piece of information is made available to the central system via a digital work product (WP) output by the second peripheral system, in that the central system collects said work product; finds an anchor piece of information or pattern (I2′) in the work product and identifies said second piece of information in said work product using said anchor. Furthermore, the second identifier comprising redundant information and the anchor piece of information or pattern comprises only a subpart of the second identifier.

The invention also relates to a system.

The present invention relates to a method and a system for performing a digital process.

In many processes within different parts of industry, several different information processing systems are involved and information relevant to the process in question is used by, and modified by, different such systems in ways that may be both complex and unpredictable. Information flow paths may vary; different systems may offer different types of API:s (Application Programming Interface) or no API:s at all; different systems may be so associated with unpredictable or ill-defined internal processing mechanisms; and human users may be allowed to modify, produce or use information at different points in said flow.

Nevertheless, in many cases it is desirable to initiate, control, monitor and follow up on such processes in a centralized manner. In particular this is the case for processes that may be well-defined on a macro level, but that consist of a plurality of sub processes that may be per se less well-defined or even unpredictable. Hence, such sub processes are performed on a micro level by various subsystems with differing characteristics and functionality.

It would furthermore be desirable to be able to increase automation in such processes, that today many times include numerous manual steps due to the disparity of the contents of the information flow, not least when manual input introduces unpredictable errors and behaviour.

Furthermore, with the advent of Software as a Service, processes do no longer typically take place on a single system, being a container of all context. Instead, processes are typically performed on multiple disconnected systems that may be connected directly or indirectly in different ways, and performing tasks related to the same macro-level process but with no correlation on the micro-level between individual tasks. This makes it very difficult to gain control and visibility over such processes in a meaningful, correlated way that allows a process operator or central server to initiate, control, monitor and follow up on such processes from one logically central point.

The present invention solves these problems.

Hence, the invention relates to a method for performing a digital process, comprising the steps of a) providing a central system; b) the central system initiating the process with a defined set of activities to be performed by respective peripheral systems being autonomous systems operating independently from said central system, said activities comprising a second activity to be performed by a second one of said peripheral systems; c) the central system, in a second request, requesting said second peripheral system to perform said second activity; d) the second peripheral system performing said second activity; e) a second piece of information resulting from said second activity being made available from the second peripheral system in question to said central system; and f) the central system updating a status of said process based on said second piece of information, the method being characterised in that the second request comprises a second identifier, the second identifier comprising redundant information; in that said second piece of information is made available to the central system in the form of a digital work product output by the second peripheral system, and in that the central system automatically performs the additional steps of g) collecting said work product; h) finding an anchor piece of information or pattern in the work product, the anchor piece of information or pattern comprising only a subpart of the second identifier and not the entire second identifier; and i) identifying said second piece of information in said work product based on a content of the anchor piece of information or pattern.

Furthermore, the invention relates to a system for performing a digital process, which system comprises a central system, said central system being arranged to initiate the process with a defined set of activities to be performed by respective peripheral systems being autonomous systems operating independently from said central system, said activities comprising a second activity to be performed by a second one of said peripheral systems; said central system being arranged to, in a second request, request said second peripheral system to perform said second activity, said central system being arranged to collect a second piece of information resulting from said second activity and made available from the second peripheral system in question to said central system, and said central system being arranged to update a status of said process based on said second piece of information, the system being characterised in that the second request comprises a second identifier, the second identifier comprising redundant information, in that the central system is arranged to collect said second piece of information in the form of a digital work product output by the second peripheral system, and in that the central system is further arranged to automatically collect said work product; to find an anchor piece of information or pattern in the work product, the anchor piece of information or pattern comprising only a subpart of the second identifier and not the entire second identifier; and to identify said so second piece of information in said work product based on a content of the anchor piece of information or pattern.

In the following, the invention will be described in detail, with reference to exemplifying embodiments of the invention and to the enclosed drawings, wherein:

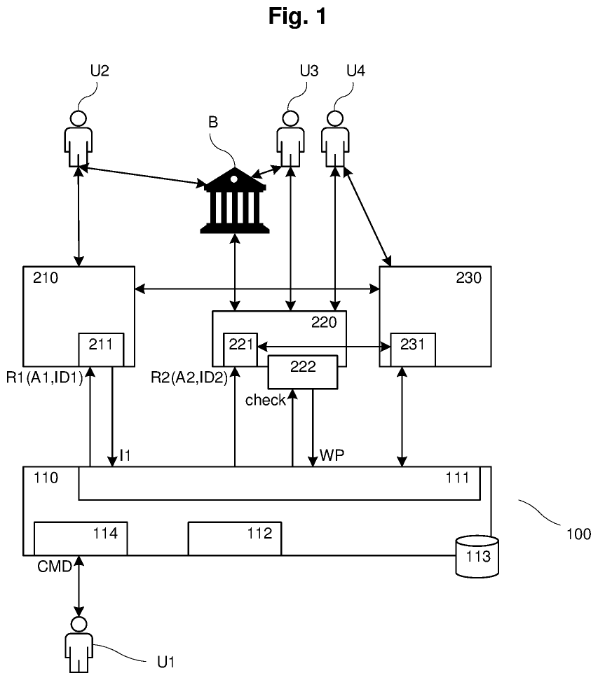

FIG. 1 is an overview of a system according to an embodiment of the present invention, in addition to peripheral systems and actors;

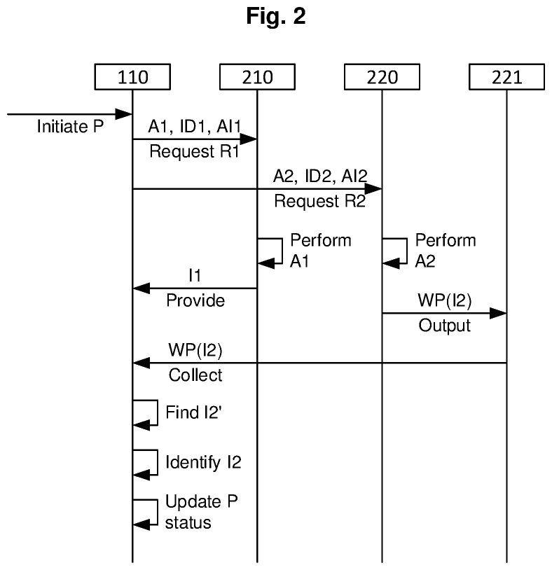

FIGS. 2-4 are respective flow charts illustrating various mechanisms in a method and a system according to an embodiment of the present invention;

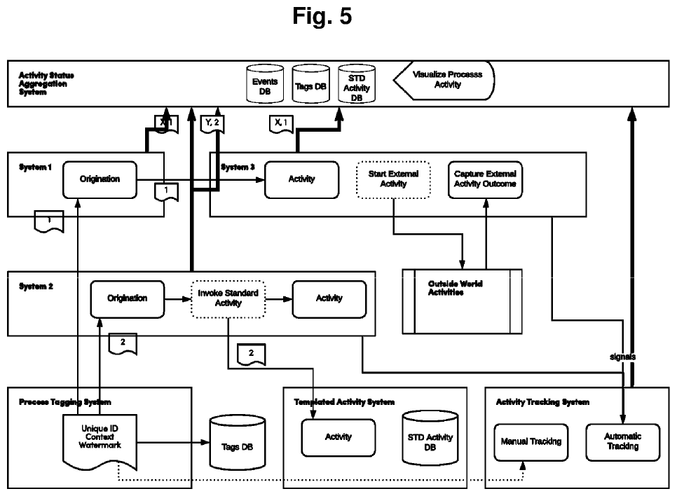

FIG. 5 is an overview illustrating an exemplifying embodiment of the present invention;

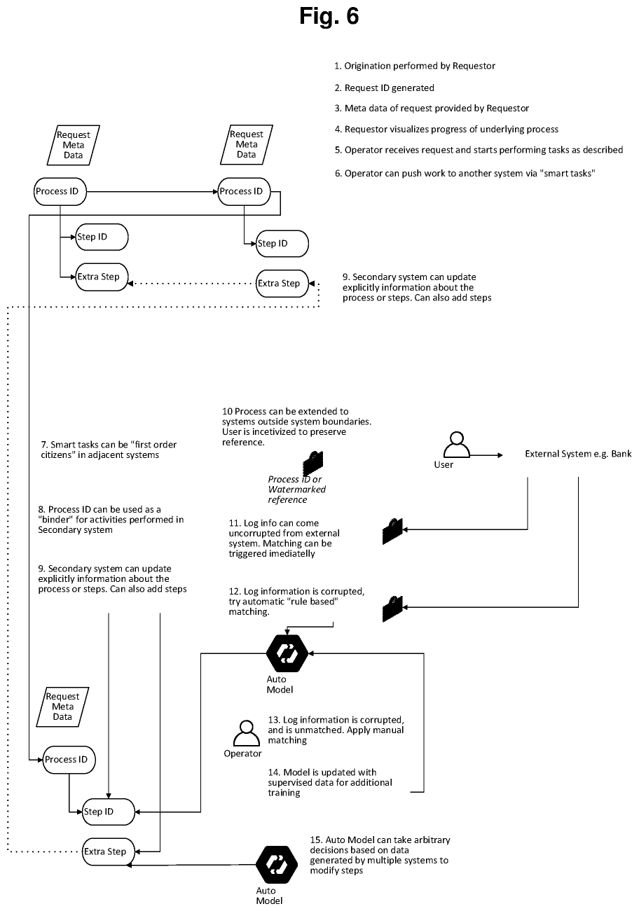

FIG. 6 is another overview illustrating an exemplifying embodiment of the present invention;

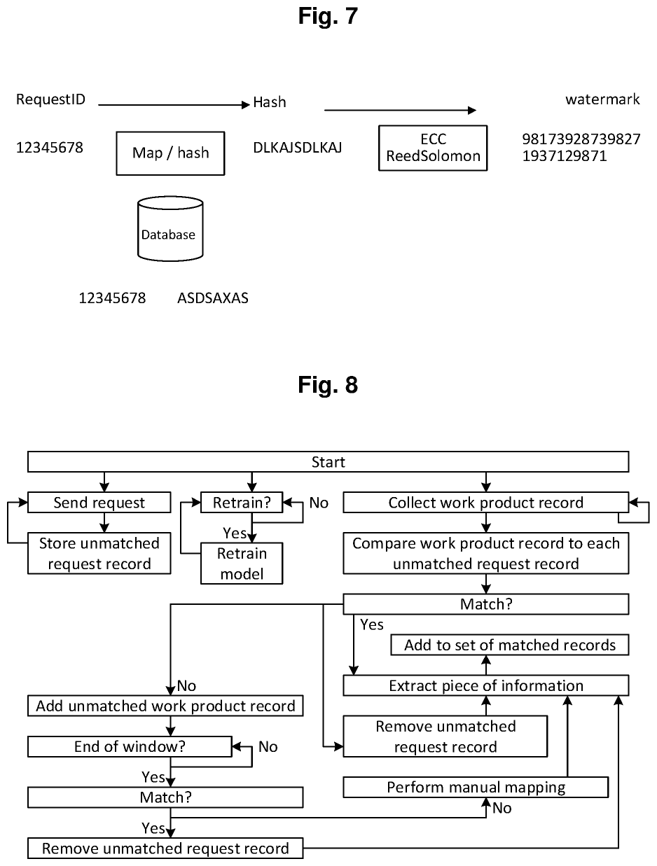

FIG. 7 illustrates a watermarking model useful in the context of the present invention; and

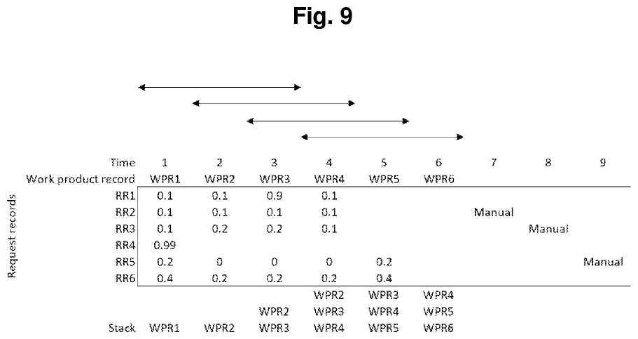

FIGS. 8-9 illustrate a matching algorithm useful in a method and a system according to an embodiment of the present invention.

FIGS. 1-4 share reference numeral for same or corresponding parts.

With reference now to FIG. 1, a system 100 according to an embodiment of the present invention is shown, said system 100 being a system for performing a digital process P.

As used herein, the term “digital process” denotes any process which is performed in the digital domain, using computers that automatically process digital information in a communication network. Such a digital process is hence an information processing process, that will typically have tangible results in the physical world in terms of activities being initiated as a result of a finalization of the entire process and/or of subparts of the process. Indeed, the digital process itself will typically comprise sub-processes that are triggered or affected by other sub-processes. Since the system 100 comprises and/or interacts with several different physical computers in a communication network, such triggering and so affecting of sub-processes performed by different physical computers will result in such physical computers performing different tasks at different times as a result of the process being executed. The execution of the digital process as such in the system will also be affected, typically be more efficient, using the present invention.

Said communication network may be the internet and/or an intranet.

The system 100 comprises a central system 110. As used herein, the term “central system” denotes a logically central functionality, which may be executed on a single virtual or physical central server and/or on several collaborating such central servers.

All functionality described herein performed automatically or semi-automatically is typically performed by executing computer software on the virtual and/or physical hardware of the central system 110 and/or correspondingly on one or several peripheral systems 210, 220, 230. Such a software function may hence be distributed in the sense that different computer software subparts are arranged to be loaded onto and executed on hardware of different virtual or physical instances, and when so executed communicate between such software subparts, via said communication network, so as to execute the digital process.

Such software is typically arranged to run on such hardware in turn comprising one or several CPUs (Central Processing Unit), one or several RAM memory modules and one or several communication buses. In case of execution in an at least partially virtual environment, a hardware environment on which the virtual environment is executed will comprise such CPU, RAM and bus.

It is hence understood that the functionality described herein, provided to perform the digital process, is implemented as a combination of suitably designed software executing on the central system 110, and a suitably designed communication topology in terms of how the central system 110 is interconnected for communication with the one or several peripheral systems 210, 220, 230 used.

It is noted that all actions described herein, being completed by various entities, are performed automatically, programmatically and in the digital domain, unless something else is indicated in the text.

Now turning also to FIG. 2, the central system 110 is arranged to perform a method according to an embodiment of the present invention. Such a method commences in a first step, in which the central system 110 initiates the digital process P with a defined set of at least two activities A1, A2 to be performed by different peripheral systems 210, 220, 230 (FIG. 1) as a part of said process P.

Such an “activity” may be any activity which at least one the peripheral system 210, 220, 230 in question is arranged to perform, such as performing a data processing or interaction with respect to a particular piece of information provided by the central system 110, the peripheral system 210, 220, 230 in question and/or by any additionally peripheral system, as the case may be. The activity may or may not involve an external human or automated user providing input to the activity or controlling some aspect of the activity in some way.

Each such “activity” may be synchronously performed, meaning that the central system 110, or the requesting peripheral system in question, locks until the activity has been completed before the central system 110 or peripheral system resumes processing of the digital process P. However, it is preferred that at least one, preferably several, preferably most or even all of the activities A1-A5 performed as a part of the digital process P are asynchronously performed, in the sense that the central system 110, or a requesting peripheral system, will perform other tasks awaiting an eventual response from the peripheral system 210, 220, 230 performing the activity A1-A5 in question.

In particular, the digital process P may advantageously be defined in terms of a set of such activities A1-A5 that all need to be completed before the digital process P itself can be deemed to have been completed. The set of activities can then be sequential, implying a predetermined order in which the activities must be performed, one after the next. However, it is preferred that the definition of the digital process P comprises rules regarding so temporal interdependencies of the activities, for instance that a particular first activity must have been completed before a particular second activity can be initiated and/or that the full or partial completion of a certain first activity automatically triggers the initiation or reactivation of a certain second activity. In other words, the central system 110 may, at each moment in time, be occupied by the monitoring and initiation of several different activities, performed in parallel on different respective peripheral systems 210, 220, 230.

Said activities A1-A5 comprise a first activity A1 to be performed by a first peripheral system 210 and a second activity A2 to be performed by a second, different, peripheral system 220.

Each of said peripheral systems 210, 220, 230 is a respective autonomous system, operating independently from said central system 110 in the sense that a respective computer software executes on the peripheral system 210, 220, 230 in question in a parallel execution flow, in relation to an execution flow of a computer software executing on the central system 110 and in relation to an execution flow of a computer software executing on any one of the other peripheral systems. The (preferably only) connection between the execution flows of the systems 110, 210, 220, 230 in question is by intra-system communication over said communication network. Such communication may, of course, result in that a particular task or piece of information presented by a first system affects the behaviour of a second system, even if the systems in question are autonomous in relation to each other.

As illustrated in FIG. 2, the central system 110 is further arranged to, in a subsequent step, request, in first request R1, said first peripheral system 210 to perform said first activity A1 and, in a second request R2, said second peripheral system 220 to perform said second activity A2.

The first R1 and second R2 requests may be sent as a part of one single, atomic request-sending event performed by the central system 110, or may be sent at different times such as following a chain of logic executed by the central system 110 according to which the first request R1 is sent when or as a result of certain conditions being met; while the second request R2 is sent when or as a result of certain other conditions being met. Either one of the requests R1, R2 may in fact be dependent upon the other request having been already sent or the activity in question already having been finalized.

As a result of said first request R1, the first peripheral system 210 performs said first activity A1, resulting in a first piece of resulting information I1.

Then, the first piece of information I1 is made available to the central system 110 from the first peripheral system 210, and the central system 110 is in turn arranged to receive the first piece of information I1 from the first peripheral system 210.

The first piece of information I1 may be automatically sent to the central system 110 by the first peripheral system 210, via API 111 (FIG. 1) and as a result of the first activity A1 being completed.

Recall that the second request R2 triggered the second peripheral system 220 to perform the second activity A2. A second piece of information I2 results from this second activity A2, and this second piece of information I2 is made available from the second peripheral system 220 to the central system 110. The central system 110 is in turn arranged to collect the second piece of information I2.

Once the first I1 and second I2 pieces of information have been received/collected by the central system 110, the central system 110 is arranged to update a status of the process P based on both the first I2 and the second I2 pieces of information. For instance, such a process P status update may be the transition of the process P into a different phase; trigger the initiating of a subsequent request to another peripheral system; resulting in the making available to a user U1-U4 of a result or part-result of the process P; and so on.

According to an embodiment of the invention, each request R1-R5 (see FIGS. 2-4) may comprise a respective identifier ID1-ID4. Hence, in the example illustrated in FIG. 2, the so first request R1 comprises a first identifier ID1 and the second request R2 comprises a second identifier ID2. The significance of these identifiers is for the central system 110 to keep track of what activities performed by what peripheral systems that relate to what parts of the process P, or even to what process P in case the central system 110 performs several processes in parallel. Hence, the first request R1 may comprise a first identifier ID1, and the second request R2 comprises a second identifier ID2. Whereas the use of the first identifier ID1 is optional, the use of the second identifier ID2 is not. Namely, the second identifier ID2 has a particular significance in that it forms a link between the second activity A2 and a result of the second activity, in turn making it possible for the central system 110 to find such result. This will be explained in more detail in the following.

With regards to the first request R1, the central system 110 is arranged to automatically receive said first piece of information I1 using an API (Application Programming Interface), being an API 211 of the first peripheral system 210 arranged to provide the first piece of information I1 to the central system 110 and/or being an API 111 of the central system 110 arranged to receive or collect the first piece of information I1 form the first peripheral system 210.

In contrast thereto, the central system 110 is arranged to collect said second piece of information I2 not via an interface (such as an API) 221 of the second peripheral system 220 but via a digital work product WP output by the second peripheral system 220 as a result of the performance of the second activity A2.

Namely, the second peripheral system 220 performs said second activity A2 as a consequence of the second request R2 being received by the second peripheral system 220, and said second piece of information I2 resulting from said second activity A2 is then made available from the second peripheral system 220 to the central system 110 as a part of said work product WP.

The central system 110 is then arranged to, in a subsequent step, automatically collect said work product WP, in turn being a digitally stored work product comprising information so resulting from the performance of the second activity.

The central system is further arranged to then search and find a particular anchor piece of information or pattern I2′ in the work product WP in question. Such an anchor piece of information or pattern I2′ may be predetermined in the sense that the central system 110 can unambiguously determine whether or not a particular found sub part of the work product WP constitutes such an anchor piece of information or pattern I2′. To do this, the anchor I2′ may be a predetermined alphanumeric text string; an alphanumeric text string that may at least partly depend on the characteristics of the second activity A2 and/or the performance thereof; a particular pattern of alphanumeric characters, the pattern being fixed or determinable on the basis of the characteristics of the second activity A2 or the performance thereof; and so forth.

Hence, the anchor piece of information or pattern I2′ may be predetermined, from the perspective of the central system 110, in the sense that it comprises a predetermined set of information and/or comprises a predetermined pattern of information.

In particular, the anchor piece of information or pattern I2′ is connected to the second identifier ID2 in the sense that the anchor piece of information of pattern I2′ either is the said second identifier ID2, is derivable from said second identifier ID2 or is associated with said second identifier ID2 in some way known or being made known to the central system 110. Said second identifier ID2 may also be derivable from said anchor piece of information or pattern I2′.

For instance, the work product WP may comprise data regarding the result of the performance of several different activities, each such result being in the form of a data record formatted in a particular set way which is known to the central system 110. The central system 110 may then identify each such record based on the known formatting pattern, and find the record comprising the second identifier ID2.

In particular, the central system 110 is arranged to identify and collect/read said second piece of information I2 in the work product WP based on a location of the anchor piece of information or pattern I2′ in the work product WP and/or based on a content of the anchor piece of information or pattern I2′ itself.

For instance, the second piece of information I2 may follow a particular formatting pattern, such as being constituted by a particular combination of letters and digits of predetermined length, and the central system 110 may then be arranged to search for such a pattern being a closest match to the anchor I2′; the second piece of information I2 may be located in relation to the anchor I2′ in a predetermined place in said work product WP; and/or the anchor I2′ may itself, as output by the second peripheral system 220, comprise information usable for the central system 110 to locate the second piece of information I2 in the work product WP. This all depends on how the second peripheral system 220 is arranged to produce said work product WP. In general, this production mechanism is known and deterministic, but will in general vary between different peripheral systems.

It is understood that the second peripheral system 220 produces the work product WP so as to contain the anchor piece of information or pattern I2′ for the central system 110 to find. This may be due to the second peripheral system 220 being designed to interact with the central system 110 in this particular manner, via the work product WP. However, it is preferred that the second peripheral system 220 is a standard system which has not been tailored in any way to produce a work product WP that is interpretable to the central system 110, but produces the work product in the standard way as it would have in response to the second request R2, without any particular configuration of the second peripheral system 220 with the specific intent to produce a work product WP interpretable by the central system 110. Instead, the central system 110 is preferably designed to provide the second identifier ID2 in the second request R2 in a way that, using a priori knowledge of how the second peripheral system 220 produces the work product WP as a result of the performance of the second activity A2, the work product WP will contain the anchor I2′ of the type described.

In other words, the central system 110 is arranged to automatically collect the second piece of information I2 from the work product WP, requiring the central system 110 to take an active part in the specifics of this collection, in particular with respect to the identification of the second piece of information I2 in the work product WP. This is in contrast to the first piece of information I1, which can either be automatically collected by the central system 110 from the API 211 or be automatically pushed to the central system 110, by the first peripheral system 210, via API 111.

As mentioned, the second peripheral system 220 may comprise an interface 221, for instance arranged to receive digital requests. However, the interface 221 needs in general not have any specific properties, as long as the second request R2 can be delivered to the second peripheral system 220 so that the second activity A2 can be initiated and performed. The only requirement is that the interface 221 supports the transfer of the second identifier ID2 as a part of the second request R2. Hence, the interface 221 may, for instance, be a programmable API, an e-mail address, or any other means of digitally receiving and interpreting the second request R2.

It is understood that the first request R1 and the second request R2 may be performed in parallel or in series, in any order, including the performance of the requested activity A1, A2 in question and the providing of the information I1, I2 in question as described above. However, at least one process P status update is performed based on both resulting pieces of information I1, I2, that must then have been received at the central system 110 before the process status update in question is performed. The process P status update may be directly or indirectly dependent on either of pieces of information I1, I2.

Using such a method and system, very diverse peripheral systems can be tied together by a suitably designed central system so as to achieve and execute an automatically performed complex digital process involving several such peripheral systems, and wherein at least one or some of such peripheral systems are not designed for such automatic control by a central system, or at least not an automatic control performed in the way desired for that particular process. This is achieved by the mechanism using the second identifier ID2 as described above, being injected as a part of the second request R2 in a way so that it ends up in the work product WP in a way detectable and interpretable by the central system 110.

How this injection can be performed may vary for various use cases. In the following, a number of examples will be provided.

In general, the central system 110 finds said anchor I2′ based on the second identifier ID2, and then uses the anchor I2′ to identify the second piece of information I2, which in turn is interpreted as information being, or having significance to, a result of the second activity A2 that has been performed by the second peripheral system 220.

In some embodiments, said work product WP is a log file output by the second peripheral system 220 as a result of the performance of the second activity A2. Such a log file may, for instance, be in the form of one or several conventional data files written by the second peripheral system 220. Then, the second request R2 may be arranged so that said anchor piece of information or pattern I2′ will exist in said log file upon activity completion by said second peripheral system 220 of the second activity A2, as a consequence of the second activity A2. For instance, the second peripheral system 220 may be, or invoke the services of, a bank B, and the log file may be a banking transaction statement output by the bank B in question. Then, the second request R2 may comprise the second identifier ID2 as a money transaction information field (for instance, an OCR number or “message to receiver” text information) that the central system 110 knows ahead of time that the bank B will add to the bank statement file together with other information regarding the transaction in question, such as an amount, a currency and a time. Then, the central system 110 may automatically access and search the bank statement log file for the provided OCR number, and, once found, use a previously known format of the log file records to identify the receiver, the amount and the time. These latter three pieces of information then constitute the second piece of information I2, which is used internally by the central system 110 to update the process P status in question.

In some embodiments, the second identifier ID2 may comprise redundant information. Hence, the second identifier ID2 may be arranged so that the central system 110 can uniquely identify the second identifier ID2 in a set of information by only accessing less than the complete contents of the second identifier ID2. In a naïve case, the second identifier ID2 may simply contain repeated copies of a particular information. However, more elaborate schemes are preferred. In a particularly preferred embodiment, the central system 110 uses a Reed-Solomon encoding to preprocess the second identifier ID2, so that a resulting alphanumeric string has a predetermined size. The size may be larger than the original second identifier ID2, hence providing said redundancy. For the central system 110 knowing how the alphanumeric string was achieved (using said Reed-Solomon encoding), it will be possible to backtrack to the second identifier using only a subpart of the alphanumeric string. How much of the alphanumeric string that is required to be able to interpret the full second identifier ID2 depends on how much said string length was expanded in the Reed-Solomon encoding, but preferred such expansions are such that it suffices to read at the most 50% of the alphanumeric string for the central system 110 to be able to recreate 100% of the second identifier ID2.

It is understood that other information-expanding, redundancy-producing coding algorithms may be used, apart from Reed-Solomon encoding algorithms.

Hence, in this case it is possible or even preferred that the anchor I2′ comprises only a subpart of the second identifier ID2, as opposed to the entire second identifier ID2. This increases the chances of a successful identification of the second piece of information I2 based on said work product WP when using a second peripheral system 210 which does not treat the second identifier ID2 provided in the second request R2 in a fully reliable or predictable manner.

Furthermore, the second identifier ID2 may comprise or fully be constituted by encrypted information. For instance, the central system 110 may be arranged to, in an encryption step performed before sending the second request R2, encrypt the second identifier ID2 before adding it to the second request R2. This provides protection from eavesdropping parties having access to said work product WP in case the second piece of information I2, or the second ID2 itself, may be of sensitive nature.

In order to identify the anchor I2′, the central system 110 may then use a corresponding public key of a PKI (Public Key Infrastructure) keypair also comprising a private key used to encrypt the second identifier ID2, and as a part of the finding of the anchor I2′ decrypt various parts of the work product WP using said public key. This may be done iteratively, such as using a priori information (being accessible to the central system 110) regarding a general formatting and/or structure of the work product WP.

It is pointed out that redundancy and encryption may advantageously be combined, in any order, to achieve both a reliable and safe process P execution.

Furthermore, in addition to the just said, or as an alternative thereto, the second identifier ID2, in its plain, encrypted and/or redundancy-expanded version, may comprise a checksum of other information comprised in the second identifier ID2. For instance, the entire contents of the plain, encrypted and/or redundancy-expanded version of the second identifier ID2 may be hashed (or signed, using a private PKI key), to form a hash digest of the contents in question. Then, this digest may be added to the contents in question before adding them to the second request R2. The hashing process may also be performed at least twice, so as to achieve a fixed-length digest.

Such hashing may be applied before or after any encryption and/or before or after any redundancy-expansion of the contents in question. Hence, the finally sent information in the second request R2 may be the second identifier ID2 as it is, or be representations of various types, after hashing, signing, encrypting and/or redundancy-expanding of the second identifier ID2. What is important is that the central system 110 has knowledge about any such pre-processing made to the second identifier ID2 and therefore is capable of finding said anchor I2′ in said work product WP. Of course, in the case where the central system 110 performs the pre-processing, it will have such knowledge.

The first identifier ID1 and the second identifier ID2, as well as any additional corresponding identifiers used in additional requests, may be the same, such as a system-global unique process identifier used to identify all or at least several of the sub-processes constituting the entire process P. However, the first identifier ID1 and the second identifier ID2 may also be different.

The task of finding the anchor piece of information or pattern I2′ and identifying the second piece of information I2 may be complex, depending on the format and complexity of the work product WP. For instance, the format of the work product WP may vary depending on external circumstances not being available to the central system 110, or the format in question may unpredictably change over time. This is because the second peripheral system 220 outputs the work product WP not with the direct, explicit or primary purpose to provide the central system 110 with the second piece of information I2, but in order to fulfil some other purposes (such as activity logging).

Therefore, the present inventor has discovered that it is efficient to use a trained machine learning model, such as a trained neural network that may be supplemented by an expert system function (rule-based logic) using a set of rules taking into consideration known constants regarding the format and contents of the work product WP, to interpret the work product WP. In particular, said finding of the anchor I2′ and/or identifying of the second piece of information I2 may be performed by a trained machine learning model 112 comprised in the central system 110.

Preferably, the model 112 may read the entire work product WP, or at least an entire well-defined subpart of the work product WP (such as a most recently output log file) in which the anchor I2′ relating to the second activity A2 in question is assumed to be present, and may then perform interpreting processing to this read entity with the objective of finding the anchor I2′. Once the anchor I2′ has been found, a machine learning analysis of a more local neighbourhood to the anchor I2′ may be performed to identify the second piece of information I2. Alternatively, the finding of the anchor I2′ and the identifying of the second piece of information I2 can take place by the model 112 performing several iterations based so on predetermined rules regarding how to proceed once the correct anchor I2′ and/or the second piece of information I2 has been found with a certain probability, the model 112 using the findings of a previous iteration as an input to a subsequent iteration until a correct finding/identification is achieved with a probability which is at least a set or determined minimum acceptable probability. In other examples, the probability determined by the model 112 that a finding of the anchor I2′ is correct may be determined based on the ability of the model 112 to find the second piece of information I2 based on the finding of the anchor I2′. In general, the model 112 may measure the probability that the finding and/or identifying is correct, and take this into consideration when presenting its findings to the central system 110. In case such a probability is above a predetermined static or dynamically updated threshold, the finding and/or identifying (as the case may be) is determined to be “correct”.

In preferred embodiments, a successful/correct such finding and/or identifying will result in a fully automatic extraction of said second piece of information I2 from the work product WP by the central system 110.

However, the finding and/or identifying may also be determined to be unsuccessful/incorrect. In this case, when the interpretation of the work product WU by the model 112 in some way is not successful or deemed to be successful/correct, such unsuccessful interpretation may automatically result in the initiation or request of an at least partly manual interpretation of said work product WP. For instance, an operator U1 of the central system 110, interacting with the central system 110 via a user interface 114 of the central system 110, may be presented with a task by the central system 110 to manually interpret the contents of the work product WP to provide the central system 110 with information regarding where to find the anchor I2′ and/or the second piece of information I2 in the work product WP. Then, a result of this manual interpretation, such as a location in the work product WP of the anchor I2′ and/or of the second piece of information I2, is fed back to a machine learning training feedback loop affecting training of said machine learning model 112 with respect to said finding and/or identifying. This will provide a very efficient way of both safeguard that no second piece of information I2 is missed while at so the same time providing directed training of the model 112 to exactly an extent necessary to improve its capability of interpreting work products WP of the current type. It is noted that the central system 110 may comprise both the model 112 and computer code arranged to train the model 112, in addition to the other central system 110 software described herein.

It is further noted that the part played by the operator U1 here is to input additional interpretation information to the central system 110 used by the central system 110 to perform the automatic interpretation of the current and subsequently collected work products WP. Hence, the manual input collecting functionality provided by the central system 110 via said user interface 114 achieves the possibility of such additional information collection from the operator U1.

The user interface 114 may be designed in different ways. Preferably, the user interface 114 is an interactive user interface, and preferably a graphical user interface presented on a computer screen connected to or comprised in the central system 110. The user interface 114 may graphically or textually represent the work product WP contents to the user, and allow the user to highlight the anchor I2′ and/or the second piece of information I2 in the user interface, and/or the user interface 114 may present a curated view of the work product WO in the sense that the central system 110 first performs preformatting of the work product WO taking into consideration information about its formatting and/or contents already known by the central system 110. For instance, the central system 110 may show only a subpart of the work product WO believed to contain the anchor I2′ and/or the second piece of information I2, or the central system 110 may highlight to the user an already found or probably found anchor I2′ and/or second piece of information I2 in the work product WO for the operator U1 to manually acknowledge.

The machine learning algorithm used by machine learning model 112 may be implemented using a matching algorithm of the type illustrated in FIG. 8.

In a first step, the algorithm starts.

In a subsequent step, a request of the above type is sent to a peripheral system as described above. This request may, hence, comprise an identifier as well as any additional information. The identifier, and possibly also such additional information, is associated with the request in question and stored in a database accessible by the machine learning model 112. Also, one or several additional parameters pertaining to the request in question but not forming a part of the request may also be associated with the request and stored in said database. For each request, an unmatched request record is created and stored, containing said information. Before storing the unmatched request record, its fields may be preformatted, such as reflecting any calculations made to the identifier as described above, for providing redundancy etc.

This step is repeated for all requests being sent to said peripheral system.

In a parallel algorithm flow, work products are collected from said peripheral system. For each such collected work product, one or several records are identified, each such record representing the output of one individual activity corresponding to one individual request. In case each activity performed by said peripheral system results in one single work product, the work product is such a record. The algorithm may use any suitable strategy to identify individual records. For instance, the peripheral system may use a newline in a log file to signal the end of a record. Such identification may build on a known working principle of the peripheral system in question, or an automatic detection of a work product format based on a predetermined set of commonly occurring work product formats and statistical mapping of the actual work products received onto such a predetermined set.

For each work product record, the work product record may subsequently be combined with each of the stored unmatched request record, and the concatenated record may then be input into the machine learning model 112 to calculate a matching score. In other words, the machine learning model 112 is applied to each combination of the work product record in question with each of the stored unmatched request records to determine said matching score.

The matching score is a measure of the estimated probability that the work product record is actually the output of an activity being partaken by the peripheral system in question upon the request corresponding to the unmatched request record in question. For instance, the matching score may be a number between 0 (estimated 0% probability) and 1 (estimated 100% probability). The matching score is hence determined by the machine learning model 112 based on the information contained in the unmatched request record and the information contained in the work product record.

In case the matching score is above a first threshold value, in a subsequent step the collected work product record in question may be determined to match the unmatched request record in question. Then, the unmatched request record is removed from the set of unmatched request records, and the piece of information is identified in and extracted from the work product in question, in the general way described above.

Matched work product records are stored in a set of such matched work product records, together with corresponding request records, and is used in machine learning model 112 retraining.

If there is no request record that results in a matching score above said first threshold value for the work product record in question, the work product record is added to a set of unmatched work products, for manual matching (see below).

Alternatively, and as is illustrated in FIG. 8, each detected work product record is associated with a certain window, which may be defined in terms of a particular time span and/or in terms of a number of received work product records from said peripheral system. Then, when at the end of said window, the work product record is again matched against every unmatched request record, and if at least one of said unmatched request record, concatenated with the work product record in the above-described way, results in a matching score above a second threshold value, being lower than the first threshold value, the work product record may be deemed matched to the request record in question. Then, this request record can be removed from the set of unmatched request records. In case no match is made at the end of said window, the work product record in question may be added to said set of unmatched work products for manual matching.

Work product records added to said set of unmatched work products may be matched to unmatched request records by manual mapping, in the general way described herein.

Once a certain predetermined minimum number or work product records, and/or a certain predetermined minimum proportion of work product records across a certain set of recently processed work product records, have been identified for manual matching, the machine learning model 112 may be retrained. Such retraining may take place based on all automatically and manually matched work product records as a training set, by forming the above concatenation of the work product record and the corresponding request record.

Regarding the mentioned additional information that may form part of the request record, this may be any data that is not sent as a part of the request, but which is yet relevant to the request in question, for instance since the additional information is known both to the requesting system and the peripheral system performing the corresponding activity. Ideally, the additional information is selected based on a likelihood for it being correlated with information contained in the resulting work product record. For instance, a social security number of a person to which the request pertains may be such additional information. This social security number may then form part of the resulting work product record, not because the social security number formed part of the request but since the activity performed is in relation to the person with that social security number. The additional information may also, for instance, comprise a time stamp and/or other contextual information.

The training of the machine learning model 112 may be based on such additional data, forming part of the matched request records. This is particularly preferred for peripheral systems and requests where it is expected that there is a correlation between such additional information and corresponding work product records.

It is noted that the machine learning model 112 may be specific to each particular combination of type of request and peripheral system. Hence, the machine learning model 112 may in fact comprise a plurality of separate machine learning models 112, each being separately and specifically trained for one particular respective combination.

Said first threshold value may be a value signifying a match with a first estimated probability. Said first estimated probability may be at least 90%, such as at least 95%.

Said second threshold value may be a value signifying a match with a second estimated probability. Said second estimated probability may be at least 30% lower than said first estimated probability. For instance, said second estimated probability may be between 40% and 70%, preferably at least 50%.

The first and second threshold values may be specific to each peripheral system, or even to each combination of peripheral system and request type.

FIG. 9 illustrates the matching process using said time window. In FIG. 9, time is simply counted in any suitable unit as “1, 2, 3, . . . ”. Collected work product records at each time are denoted “WPR1, WPR2, . . . ”. Stored request records are denoted “RR1, RR2, . . . ”. In the table shown in FIG. 9, the numbers between 0 and 0.99 represent estimated probabilities for a match, calculated by applying said trained machine learning model 112. The “Stack” represents the stored unmatched work product records at each time. The arrows at the top of FIG. 9 illustrate consecutive time windows for each consecutive collected work product record.

In the example of FIG. 9, the first threshold value is 99% match probability, and the second threshold value is 60% match probability.

Hence, at time 1 work product record WPR1 is observed. It is matched with a set of stored unmatched request records RR1-RR6. RR4 matches at 0.99, meaning 99% probability that there is a match between RR4 and WPR1. RR4 is removed from the set of unmatched request records, and WPR1 is processed in relation to RR4, its piece of information being extracted and WPR1 not being stored in the set of unmatched work product records.

At time 2, WPR2 is observed, but does not match any of the request records at 90%. WPR2 is kept on the stack, forming the set of unmatched work product records.

At time 3, WPR3 is observed. It is not matched to any request record at 99% probability, so it is kept in the stack.

At time 4, WPR4 is observed. It is not matched to any request record at 99% probability, so it is kept in the stack. However, the time window of WPR2 ends, why it is investigated if WPR2 matches any of the request records at 60% probability. This is not the case, why WPR2 is marked for manual matching.

At time 5, WPR5 is observed. It is not matched to any request record at 99% probability, so it is kept in the stack. The time window of WPR3 ends, and it is investigated if WPR3 matches any of the request records at 60% probability. This is found to be the case for RR1. Hence, RR1 and WPR3 are matched and processed accordingly.

This way, the process continues with WPR6 and so on. At a later point, it may be determined that RR2, RR3 and RR5 were not matched with any work product records. As a result, they too may be marked for manual matching. Similarly to the collected work product records, each request record may be associated with a corresponding request record time window, at the end of which it may be tested against the unmatched work product records at the second threshold value in the above-described way.

As mentioned above, the machine learning model 112 may operated on a combination of a particular request record and a particular work product record, forming a record pair. In some embodiments, the combination may be a concatenation of a respective text string representing each of said two records in said record pair.

In such a text string representation, each parameter or attribute (such as the identifier, any additional pieces of information, the piece of information in the work product, and so forth) may be separated using a predetermined character, such as a hashtag “#” character.

In case the work product record is structured in a way that it is at least partly known or possible to infer, the work product record can be segmented into such attributes, otherwise the work product record may simply form the text string representation without such preformatting. In order to unambiguously determine the text string representation of a work product record, a “beginning” and an “end” must be identified. This can be done in any suitable and well-defined way, such as interpreting a newline character in a log file as the end of a record.

One efficient way of applying the machine learning module 112 is to encode the string concatenation using a onehot encoding, representing each character with a binary string where one single bit representative of the character in question is set to 1 while all other bits are set to 0. The following is an example of such an encoding, based on a request record with attributes “ID” and “INFO”, and a work product record with attributes “XYZ”:

| String | | | | | | | | | | | | |
|---|---|---|---|---|---|---|---|---|---|---|---|---|
| representation | I | D | # | I | N | F | O | # | # | X | Y | Z |
| A | 0 | 0 | 0 | 0 | 0 | 0 | 0 | 0 | 0 | 0 | 0 | 0 |
| B | 0 | 0 | 0 | 0 | 0 | 0 | 0 | 0 | 0 | 0 | 0 | 0 |
| C | 0 | 0 | 0 | 0 | 0 | 0 | 0 | 0 | 0 | 0 | 0 | 0 |
| D | 0 | 1 | 0 | 0 | 0 | 0 | 0 | 0 | 0 | 0 | 0 | 0 |
| E | 0 | 0 | 0 | 0 | 0 | 0 | 0 | 0 | 0 | 0 | 0 | 0 |
| F | 0 | 0 | 0 | 0 | 0 | 1 | 0 | 0 | 0 | 0 | 0 | 0 |
| G | 0 | 0 | 0 | 0 | 0 | 0 | 0 | 0 | 0 | 0 | 0 | 0 |
| H | 0 | 0 | 0 | 0 | 0 | 0 | 0 | 0 | 0 | 0 | 0 | 0 |
| I | 1 | 0 | 0 | 1 | 0 | 0 | 0 | 0 | 0 | 0 | 0 | 0 |
| J | 0 | 0 | 0 | 0 | 0 | 0 | 0 | 0 | 0 | 0 | 0 | 0 |
| K | 0 | 0 | 0 | 0 | 0 | 0 | 0 | 0 | 0 | 0 | 0 | 0 |
| L | 0 | 0 | 0 | 0 | 0 | 0 | 0 | 0 | 0 | 0 | 0 | 0 |
| M | 0 | 0 | 0 | 0 | 0 | 0 | 0 | 0 | 0 | 0 | 0 | 0 |
| N | 0 | 0 | 0 | 0 | 1 | 0 | 0 | 0 | 0 | 0 | 0 | 0 |
| O | 0 | 0 | 0 | 0 | 0 | 0 | 1 | 0 | 0 | 0 | 0 | 0 |
| P | 0 | 0 | 0 | 0 | 0 | 0 | 0 | 0 | 0 | 0 | 0 | 0 |
| Q | 0 | 0 | 0 | 0 | 0 | 0 | 0 | 0 | 0 | 0 | 0 | 0 |
| R | 0 | 0 | 0 | 0 | 0 | 0 | 0 | 0 | 0 | 0 | 0 | 0 |
| S | 0 | 0 | 0 | 0 | 0 | 0 | 0 | 0 | 0 | 0 | 0 | 0 |
| T | 0 | 0 | 0 | 0 | 0 | 0 | 0 | 0 | 0 | 0 | 0 | 0 |
| U | 0 | 0 | 0 | 0 | 0 | 0 | 0 | 0 | 0 | 0 | 0 | 0 |
| V | 0 | 0 | 0 | 0 | 0 | 0 | 0 | 0 | 0 | 0 | 0 | 0 |
| X | 0 | 0 | 0 | 0 | 0 | 0 | 0 | 0 | 0 | 1 | 0 | 0 |
| Y | 0 | 0 | 0 | 0 | 0 | 0 | 0 | 0 | 0 | 0 | 1 | 0 |
| Z | 0 | 0 | 0 | 0 | 0 | 0 | 0 | 0 | 0 | 0 | 0 | 1 |
| # | 0 | 0 | 1 | 0 | 0 | 0 | 0 | 0 | 1 | 1 | 0 | 0 |

Known aspect about the structure of the information contained in the request records and/or the work product records can be exploited in the encoding. For instance, if it is known that a particular attribute always assumes one of a limited set of values, each such value can be awarded a binary representation being fed into the onehot encoding.

The present inventors have discovered that, for many of the embodiments described herein, that either a GRU+Attention model or a 1D-CNN model work particularly well as the machine learning model 112.

In some embodiments, the second piece of information I2 may itself have a predetermined format, and the central system 110 may then identify said second piece of information I2 as a piece of information having said predetermined format and being present in the same work product WP that also comprises said anchor piece of information or pattern I2′. In the example of a bank statement log file discussed above, it may be the case that the second piece of information I2 is a bank account number, having a particular format in the sense that it contains a particular number of digits and blank spaces or hyphens in a certain order. Then, a line of the log file may be identified as the line containing the anchor I2′, and the so second piece of information I2 is identified as the bank account number on that same line, based on pattern recognition using said known bank account number format.

As illustrated in FIG. 1, the second peripheral system 220 may comprise or be in communication contact with a storage area 222, for instance in the form of a dedicated hard disc space or any type of database. The storage area 222 may be accessible directly, such as by accessing the hard disc space or database in question with read/write operations, such as via a conventional file system access or SQL queries, or alternatively via a suitable API. The second peripheral system 220 may write (output) the work product WP directly to the storage area 222, or a mechanism may be implemented to transfer work products from an internal storage area of the second peripheral system 220 to the storage area 222. In the latter case, such a mechanism may be a mechanism of the second peripheral system 220 or a purpose-designed mechanism implemented on top of the second peripheral system 220. What is important is firstly that the second peripheral system 220 is not as such modified to work in any particular manner with the central system 110, in the sense that the second peripheral system 220 is arranged to output its normal work product WP without any particular consideration to the functionality of the central system 110, and secondly that the central system 110 has at least read access to the storage area 222.

Hence, the storage area 222 may be a part of the second peripheral system 220, or may be external to the second peripheral system 220 but then be a location at which the second peripheral system 220 conventionally outputs its work products WP.

The central system 110 may be arranged to, as a part of its collection of the second piece of information I2, check the predetermined information storage area 222 for updates. If the storage area 222 comprises updated work product WP information, the central system 110 may then be arranged to identify said work product WP in the storage area 222 and to automatically read the work product WP from the storage area 222.

As an alternative to the central system 110 collecting the work product WP directly from the storage area 222 by reading the storage area 222 in said manner, the collection by the central system 110 of the second piece of information I2 may comprise a plurality of work products being provided to the central system 110, such as by the second peripheral system 220 or by a second mechanism of the type described above. Then, the central system 110 may identify one particular work product WP, such as one particular log file, among said plurality of work products, and to find said anchor piece of information or pattern I2′ in said particular work product WP. The identification of said one particular work product WP may be performed in various ways, such as using the presence of the anchor I2′ in the particular work product PW, based on work product timestamps, and so on.

As is illustrated in FIG. 1, the central system 110 may comprise or be in communication connection with a central database 113. This database 113 may itself be of any suitable type, such as a standalone or distributed central database, a relational database, etc., and is in turn arranged to store said first ID1 and second ID2 identifiers. The database 113 may preferably be arranged to store any process P defining information and all or some of any other central system 110 pertinent information described herein.

In particular, at least one standardized type of activity (in other words an activity template) may be defined by a respective set of template-defining parameters. For instance, such parameters may specify one or several of a particular type of peripheral system (or a particular peripheral system) to which one or several requests are to be sent; type of data fields to include in such requests; and actions for the central system 110 to take in response to the receipt of corresponding pieces of information from the queried peripheral systems in question.

Individual activities, such as said first A1 and/or second A2 activity, may then be defined as one available such standardized type of activity, and further by activity-specific parameter data specifying the details of the activity in question (such as in relation to which one of a set of available users U2, U3, U4) to which the activity in question relates; transaction-specific data such as a money amount, etc.). What activity-specific parameter data that need to be specified may be defined by said template-defining parameters, and all parameters discussed here may be stored in the database 113.

Other parameters in the database 113 may determine how to communicate with different types of peripheral systems, how to interpret work products or received pieces of information, and so on.

In particular, the first A1 and/or second A2 activity may be defined as such a parameterized activity, hence via values of a predetermined set of activity-defining parameters stored in the database 113. The central system 110 may then request R1, R2 at least one such activity A1, A2 based on said activity-defining parameter values.

Of course, each activity A1, A2 may be defined directly by such activity-defining parameters, without using parameterized activity templates. Even though parameterization of activities in both cases provides a very efficient way of quickly configuring the process P and allowing the central system 110 to perform it in an efficient and robust manner, the use of activity templates will further increase this efficiency.

To achieve a fully configurable yet completely automated process P execution, the present inventor has found it advantageous to define the entire process P as a standardized process defined by respective values of a predetermined set of process-defining parameters, the parameter values of which may be stored in the database 113. Then, the central system 110 may automatically identify and execute the activities comprised in the process P based on said process-defining parameter values.

It is understood that the process P may comprise decision points and interdependencies between different activities, and may therefore be non-linear in the sense that it is difficult or impossible to, ahead of time, foresee a final order of activities to perform. Such decision points, interdependencies and other process execution logic is preferably also defined in said process-defining parameters.

In particular, said process-defining parameters may comprise at least one parameter defining a finalized state of the process P. Then, the central system 110 may automatically perform a predetermined finalization action, such as sending a message to the operating user U1, in reaction to said finalized state being detected by the central system 110, said “finalized state” being determined to occur based on said finalized-state defining parameter(s).

As mentioned above, the central system 110 may provide an interactive UI (User Interface) 114. Then, the UI 114 may comprise said updated status, in other words it may make the updated status available directly or in processed form to the operating user U1.

Furthermore, the UI 114 may be arranged to receive a command CMD from the operating user U1, defining a status change of the process P, and the central system 110 may be arranged to, as a result thereof, execute said change. In other words, the operating user U1 may interactively control the progress of the process P. Preferably, such control is then made possible, by the central system 110, within the boundaries defined by the current process-defining parameter values defining the process P in question.

It is realized that the central system 110 may be arranged to perform several processes in parallel, each being defined by a different set of process-defining parameters, and that said user U1 interaction may then be in relation to a particular one of several available such processes currently being performed by the central system 110.

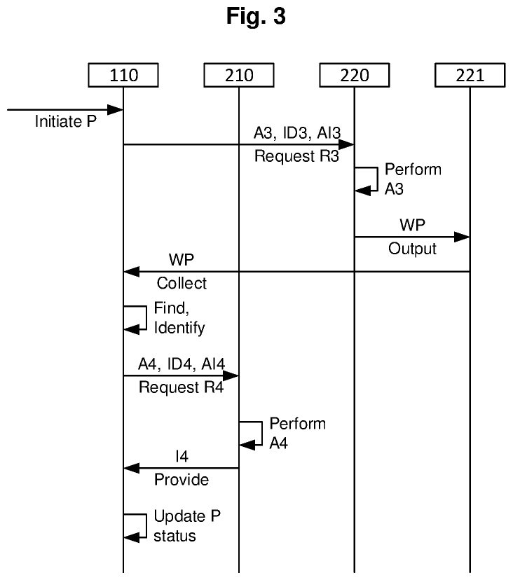

Turning to FIG. 3, an embodiment of the present invention is illustrated in a flow chart similar to the one shown in FIG. 2. In this embodiment, according to a definition of the current process P, at least an alfa one A3 of the activities must be completed before a different, beta, one A4 of the activities can be requested.

Hence, after the central system 110 initiates the process, the alfa activity A3 is requested by the central system 110 to the second peripheral system 220, using request R3 comprising a third identifier ID3. The second peripheral system 220 performs the activity A3 in question, and outputs the work product WP to the storage area 221 in a way corresponding to what has been described above.

The central system 110 collects the work product WP as described above, finds the corresponding anchor and identifies the corresponding piece of information resulting from the alfa activity A3.

Then, once this piece of information has been identified by the central system 110, the central system 110 can take the next step in the process P and request said beta activity A4 from the first peripheral system 210, in a request R4 comprising a fourth identifier ID4. The first peripheral system 210 then performs the beta activity A4 and provides the resulting piece of information I4 to the central system 110, which can then update the process P status based on both pieces of information.

In particular, the central system 110 may be arranged to automatically request said beta activity A4 from the first peripheral system 210 as a result of said alfa activity A3 being finalized and the corresponding piece of information being identified by the central system 110.

In addition to the operating user U1 being able to provide process P update information via UI 114, or as an alternative thereto, the central system 110 may also be arranged with an API 111 via which it is arranged to receive process P status update information from other computer entities, such as from one or many of said peripheral systems 210, 220, 230.

In certain embodiments, such process P status update information is received by the central system 110 from one or several peripheral systems, but not as a direct response to a request for an activity (as described above) sent to the peripheral system in question. Instead, such process P status update information may be initiated by one or several events occurring externally to the central system 110.

In other words, one or several of said peripheral systems 210, 220, 230 may provide process P status input to the central system 110 via said API 111 based on such an external event, affecting the execution of the process P in question. As will be exemplified below, in combination with the orchestration by the central system 110 of activities across both peripheral systems 210 with which the central system 110 may communicate directly and peripheral systems 220 where communication needs to take place more indirectly (via said work products PW), the possibility for such peripheral systems 210, 220 to provide direct input to the central system 110 provides a powerful way of performing dynamically executed processes P, where the process execution can take place iteratively in bidirectional collaboration between the central system 110 and one or several peripheral systems 210, 220, 230, and dynamically adapt to events accruing during such execution.

Said external event(s) may comprise, for instance, a user U2-U4 manual input received by a peripheral system 210, 220, 230 or a digital input automatically received by a peripheral system 210, 220, 230 from an external entity.

It is preferred that at least one, such as at least some, or even all, peripheral systems 220 of the type using work products WP as the mechanism for indirectly providing information resulting from performed activities back to the central system 110, do not use the API 111. Thus, such peripheral systems 220 may be left completely unaffected by their usage in the present system 100, and can be left without any specific configuration for use in the system 100.

As is illustrated in FIGS. 2-5, each one of said first request R1, R2, R3, R4, R5 may comprise respective additional information AI1, AI2, AI3, AI4, AI5, pertaining to the respective activity A1, A2, A3, A4, A5 to which the request in question relates, apart from the respective identifier ID1, ID2, ID3, ID4 in question. Such additional information may be any metadata information that the peripheral system 210, 220, 230 in question requires to perform the activity in question, such as in relation to what user U2, U3, U4 the activity is to be performed; a money amount; an account number; a piece of identifying or login credentials; a free-text comment field; etc.

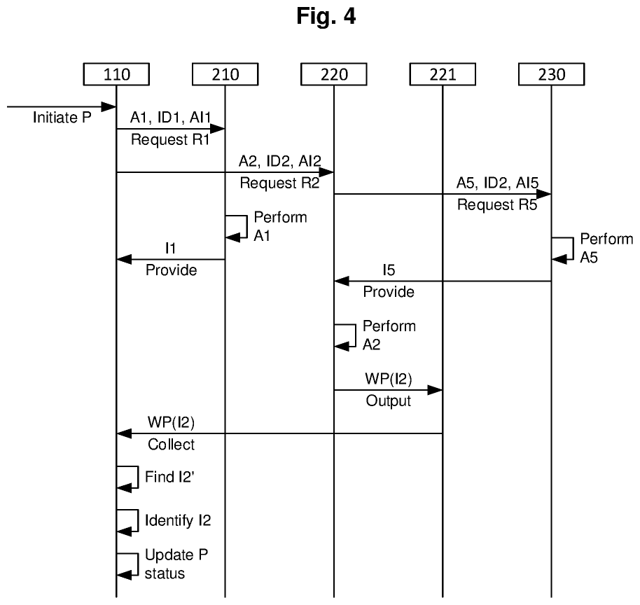

Turning to FIG. 4, another embodiment is illustrated, in which at least one of the first 210 or second 220 peripheral systems, as a part or consequence of the request R1 or R2 made from the central system 110 to the peripheral system 210, 220 in question, invokes another peripheral system 230 to perform a delta activity A5, in a request R5. The request R5 may comprise the same identifier ID1 or ID2 provided to the peripheral system 210, 220 in question, or another identifier specific to the request R5 in question. In FIG. 4, as an example ID2 is used in request R5.

Hence, the first 210 and/or second 220 peripheral system may use yet another peripheral system 230 to delegate certain subtasks of the requested activity A1, A2 in question, by automatically invoking the third peripheral system 230 in question. The third peripheral system 230 may be of a type corresponding to peripheral system 210 (with direct communication to the central system 110) or of a type corresponding to the peripheral system 220 (with indirect communication to the central system 220). In the latter case, the corresponding mechanism for communicating a piece of information resulting from activity A5 may be applied by the requesting peripheral system to the third peripheral system 230, in that the requesting peripheral system collects a work product output by the third peripheral system in a way corresponding to the one described above; or the central system 110 may be arranged to collect a work product output by the second peripheral system 220 and/or a work product output by the third peripheral system 230, from the same or different storage areas.

In the example shown in FIG. 4, the peripheral system 230 is of said first type, using an API 231 to directly communicate a fifth piece of information I5 to (API 221 of the) the second peripheral system 220 or (API 111) of the central system 110, depending on the details of the process P.

Such delegation of subtasks may be performed in several layers, that may or may not be nested, whereby one peripheral system invokes a different peripheral system in turn invoking yet another peripheral system. Such an in-turn invoked peripheral system 230 may so even be part of the central system 110.

As is also illustrated in FIG. 4, the central system 110 in this case initiates the process P, after which it requests R1 the first peripheral system 210 to perform activity A1 and requests R2 the second peripheral system 220 to perform activity A2.

Peripheral system 210 performs activity A1 and provides piece of information I1 to the central system 110.

In parallel thereto, the second peripheral system 220, as a result of request R2, requests R5 the third peripheral system to perform activity A5. The request R5 comprises the same identifier ID2 as request R2.

In response to said request R5, the third peripheral system 230 performs activity A5 and makes available the fifth piece of information I5, resulting from the performance of activity A5, to the requesting second peripheral system 220 in a suitable way as discussed above.

The second peripheral system may use the piece of information I5 during the performance of activity A2. When finished with activity A2, peripheral system 220 makes available piece of information I2 to the central system 110 as discussed above, via work product WP and anchor I2′.

The central system 110 in turn receives/collects all pieces of information I1, I2, and possibly also I5, and uses this information to update the process P status.

As mentioned above, the present process P may be of many different types. One example is a collaborative process in which several participating users U2, U3, U4 may be involved in corresponding and/or different capacities. For instance, such collaborative process may involve certain users needing to sign particular agreements, pay agreed-upon money or input certain information. One concrete example is a so-called “drawdown” process, in which several investing and decision-making users U2, U3, U4 are required to acknowledge so a particular joint investment and to each transfer a particular amount of money to a particular account.

Such a drawdown process P may comprise the following sub-activities:

A user A requests an investor drawdown, via a peripheral e-mail or electronic digital ticketing system. A user B approves the request, via said ticketing system or a peripheral digital signing system. User C prepares letters to investors, and books the receivable, using a peripheral electronic accounting system. User C further sends said letters to investors requesting a drawdown, using a peripheral e-mail system. Investors each pay the drawdown to the bank, using a peripheral electronic banking system. User C reconciles the bank transactions with the accounting, using said accounting system, and further informs user A and B of completion of the process. All of said activities are centrally organized by a central system of the present type, and are tied together using identifiers as described herein.

Other examples of processes P include a financial auditing process, where different users are responsible for providing different quality-secured and/or authenticated information, and other users are responsible for authenticating or undersigning certain information.

Yet additional examples include industrial procurement, development, delivery or maintenance projects, in which various users may be responsible for taking decisions based upon certain defined information; other users are responsible for providing certain information; and other users are responsible for performing certain external activities.

Hence, the possible applications of processed in which the present method and system may be useful vary considerably. Such processes may comprise activities ranging from authentications, authorizations, verifications, simple acknowledgements, transfers of funds and information, information processing, and so forth. For all such applications, however, a central system 110 is used to organize the automatic performance of a plurality of sub-activities by independently operating peripheral systems of different types.

As also mentioned above, certain of said users U1-U4 may be human users, while other users are automated users. Such automated users may, for instance, be in the form of web services, chat bots or other entities arranged to provide certain well-defined digital services to requesting entities. Examples include information lookup services, e-mail services, web publishing services, the bank B, and so forth.

As illustrated in FIG. 1, the various users U2, U3, U4 may each communicate with a particular one or several of the peripheral systems 210, 220, 230, with the bank B or any other automated user, in more or less complex patterns, depending on the type of process P.

Using system 100, a central system 110 operating user U1 is allowed not only to visualise work in progress of the process P, but also to quickly and flexibly be able to view information about duration of activities and bottlenecks, thus providing detailed information for performing analysis of process P performance and improvements. This is in contrast to a process being executed on multiple of disconnected systems, performing tasks related to the same process but with no correlation, and without any orchestrating central system 110 of the type described herein.

FIG. 5 illustrates an exemplifying embodiment of the present invention, in which a central system of the present type and three different peripheral systems of the present type collaborate to perform a process of the present type. In FIG. 5, the central system comprises the “Process Tagging System”, the “Templated Activity System”, the “Activity Tracking System” and the “Activity Status Aggregation System”. “System 1”, “System 2” and “System 3” are all peripheral systems of different types.

As an alternative, the “central system” in the example illustrated in FIG. 5 may also include “System 1”, which is then the original initiator of the activity labelled “1”. Then, “System 2” may be another part of the “central system”, being the original initiator of the activity labelled “2” in FIG. 5, and/or “System 3” may be another part of the “central so system”. This goes to show that the “central system” may be configured in many different ways, as long as the central system as one logical unit coordinates the performance of the process in turn encompassing several activities.

The process is initiated by a first activity “1” being originated at System 1. System 1 is provided, in a request, from Process Tagging System, with a unique instance tag containing a unique identifier, context about the process being performed and a unique watermark.

The unique instance tag is generated by the Process Tagging System and is stored in a tag database (“Tags DB”) which can be used to reconstruct the original instance. The unique instance tag is used to tint/contaminate every activity and log in the systems the actions of which are initiated by the activity “1” performed by System 1, or even the entire process.

System 1 can handover the instance tag to adjacent systems, such as “System 3”, which will do the corresponding.

In a way corresponding to the initiation of activity “1”, activity “2” is performed by System 2 based on a different unique identifier provided by the Process Tagging System.

Systems can invoke centralised standard activities that initiate activities from other systems. These activities will generate curated contextual information. In the example shown in FIG. 5, System 2 invokes such a standard activity as a part of activity “2”, based on parameter information from Templated Activity System in turn stored in database “STD Activity DB”.

Systems can also invoke peripheral systems of the above described type, communicating information back to the central system or requesting information from peripheral systems indirectly, via work products. This is illustrated in FIG. 5 by the “Outside World Activities” box, accepting an “External Activity” initiated by System 3 as a result of activity “1”. It is noted that the “Outside World Activates” in its capacity as a “peripheral system” in the terminology used herein can be invoked by a request sent by either the central system (such so as “System 3” as illustrated in FIG. 5, if System 3 is a part of the central system, or directly from a different part of the central system) or by a peripheral system (such as “System 3” if this itself is considered to be a peripheral system).

The “Outside World Activities” provides a work product (“External Activity Outcome”), which is captured by “System 3”. The External Activity Outcome comprises the watermark and/or unique ID sent as a part of the “Start External Activity” request sent by System 3 to the “Outside World Activities”.

The Activity Tracking System is arranged to accept activity report progress information from users of the system. Such reporting can be provided manually via user interface or API “Manual Tracking”. Activity Tracking System may also allow such users to visualise and confirm implied activity progress generated by the Activity Tracking System, such as via the same user interface or API. The Activity Tracking System can receive activity progress or finalization signals from the various systems involved, to keep an updated view of the progress and status of various activities performed as a part of the process.

The Activity Status Aggregation sub-system analyses work products (such as logs) captured (such as by System 3), and correlates found instances of the watermark and/or unique ID in said work products, and possibly also other unique signs, to produce inferred activity related to the original activity in question. This correlation allows the Activity Status Aggregation System to follow signals uniquely linked to Tag. To do this, the Activity Status Aggregation System also has access to the “Tags DB” and the “STD Activity DB”.

The Activity Status Aggregation System also provides a way for a process-managing user to, via a suitable API as described above, visualize process activity based on said inferred information and status update reports provided by various central system subsystem and/or peripheral systems.

It is realized that, in the FIG. 5 example, the identifier sent in each request is the so “watermark”. In addition to this watermarking information, a unique activity identifier is also used to keep track of each individual activity internally. This “unique activity identifier” may also be sent in each request, such as by using the mentioned “unique tag” as a data package always following each activity in all instances.

As an example, a series of captured log file entries from different systems (Sys1, Sys3, External) may have the following contents (comments within parentheses not being part of the log file information):
1. Sys1; . . . TAG1 . . . . (activity A)
2. Sys3; . . . . TAG1 . . . XYZ (activity B)
3. External; . . . XYZ (activity C)
4. Sys3; . . . XYZ (activity D)
5 . . . .

In this case, the process comprises activities A, B, C, D, E, and is initiated with reference to an identifier TAG1 which is common to all activities and systems. Activity C is performed by the external system “External”.

However, the external system does not output TAG1 as a part of its log file entry. Then, heuristics are used that allow the system to infer the relevant log file output from activity C. This is done by automatically identifying derivative products generated by other systems (Syst1, Sys3) that allow the central system to infer information TAG1 from other output log file information.

In particular, we may observe that a prior step by Sys3 (activity B) has generated an identifier XYZ simultaneously (in the same log file entry) with TAG1, and we also observe that the external system, as a result of activity C, outputs this same identifier XYZ. The information XYZ may be identifiable by the central system by XYZ in some way being correlatable to the process or transaction.

Hence, identification of such information XYZ in the log file output from a first subsystem may be used to “enrich” information output by a second subsystem by correlating the information XYZ with an identifier of the present type in the first subsystem and using this correlation as a mapping rule when analysing log file information output by the second subsystem, in effect determining that the analysed log file entry from the second subsystem pertains to the process in question by inference.

FIG. 6 provides another embodiment example of a system and a method according to an embodiment of the present invention.

At item 1, origination of a new process is done via a predefined system (Request Portal) which is also the master record of instances and activities lists. In other words, this is the system that keeps everything together, the “central system” in the terminology used herein.

This Request Portal of the central system hence provides an API arranged to accept requests for new processes from external entities, so that any other system can trigger the creation of a new process. For example, the initiation of a new process may be requested using any external communication platform using said API, whereas the actual creation, initiation and execution in question will be performed by the central system. A Request ID for the process is generated by the central system (item 2), and meta data of the request in question is provided by the entity making the request for initiation of the process in question (item 3).

Said Request Portal may also provide a user interface providing information regarding overall process P progress, and in particular as compared to an expected process P progress which in turn is statistically calculated by the Request Portal based on previous executions of processes having the same or corresponding parametric definition and/or that contain sub processes defined by same or corresponding parameter values.

Once created, the process will be executed by an executing part (the “Operator”) of the central system, and process progress may be visualized (item 4), by the Requestor using a suitable graphical user interface.

The Operator receives (item 5), the request in question, and starts performing the corresponding activities (“tasks” or “steps”) as specified in the request and as specified using any used process-defining parameters.

The Operator can push activities to central system subsystems or peripheral systems using “smart tasks” (items 6 and 7), that is tasks identified using a “Step ID” as a watermark of the above described type. Such tasks can then be considered “first order citizens” (top-level tasks) in the performing entities.

At the same time, the “Process ID” is used (item 8) to bind together all activities performed as a part of the requested process in various sub systems.

Any participating sub system may actively update explicit information about individual activities or the entire process (item 9). Such sub system can even add additional activities, that are then initiated with their own “Step ID”.

Using the watermarking mechanism according to the present invention, the process execution can be extended to systems outside of the system boundaries (item 10). In case such peripherally-performed activities involve manual user tasks, such an active user may be incentivized to preserve the watermarking reference. For instance, a sub system initiating an external activity involving a human user performing a money transaction using a peripheral online banking system, the sub system in question may, in its request sent to initiate this external activity, add information regarding the watermark with the specific instructions to the human user to add this watermarking information in an “OCR” or free-text “message” field of the bank transfer. It is, however, preferred that all watermarking information is added automatically by each participating peripheral system.

In case (item 11) log info arrives from the peripheral system back to the central system uncorrupted, in other words that the log information can be immediately reliably interpreted (finding the anchor and identifying the piece of information as described so above), the piece of information can be put to use and trigger a corresponding action (or the like) immediately.

In the other case (item 12), where the log info cannot be immediately reliably determined, for instance if the read log file is corrupted, an automatic rule-based and/or neural network/machine learning matching can be automatically applied, with the aim of correctly identifying the piece of information fed back from the peripheral system. This attempt can be made by the “Auto Model” as shown in FIG. 6.

In case this attempt is unsuccessful (item 13), a manual matching is initiated, by informing a corresponding user (“Operator”) about the necessity to perform such a manual interpretation of the log file.

Based on this manual matching, the machine learning model is updated (item 14).

In item 15, it is shown how the automatic rule-based/machine learning matching of a work product can result in the triggering of an additional activity and/or the modification of an activity, performed by the peripheral system or central system sub system receiving the log file in question, or any other peripheral system or central system sub system. For instance, the identified piece of information may prove incomplete and may therefore by deemed, by the Auto Model to require, as an additional activity (“Extra Step”) an information qualification or supplementation step in order to be useful in the intended manner in the process.

As mentioned above, a system according to the present invention may be arranged to allow several different users U2-U4 to interact with the system to perform different actions. Some such users may take active part in the completion of certain activities of part of activities. Such users are then provided with information and/or instructions that they should perform a certain task, using some type of user interface arranged to automatically provide such information/instructions as a part of the performance of a particular activity.

In some embodiments, a system according to the present invention is arranged with a particular subsystem arranged to provide such a user interface, preferably a graphical user interface, to several users of the system with respect to different activities each performed by one of said users. Each such user may then, using said user interface, pick a task and start working on it as needed. Such a user interface may also be arranged to provide intra-user communication functionality, as well as an activity progress indicator. Below, such a user interface is denoted a “request portal”.

Such a request portal may be arranged to allow each requesting and/or performing user to perform and/or view the progress of one or several of the following types of actions in relation to a particular request or a particular activity that the user in question partakes in:

Manual Actions—Actions where the user, by clicking or otherwise, verifies that a particular action to be completed as a part of the activity in question has indeed been completed.

Trigger Actions—Actions where the user, by clicking or otherwise, signals that a system is to perform an automatic action on behalf of the user in question.

Automatic Actions—Actions that are marked as completed when a supervisor system determines that the underlying goals, as defined by the activity in question, have been completed.

A graphic user interface of said type may further comprise a visualization of the progress of a particular activity in which the user in question currently partakes, or the progress of the entire process which the user in question has initiated or monitors.

Such an activity progress indicator may show, in a checklist-like manner, activity tasks that have been completed already, and possibly by what user, and what tasks must still be completed before the activity in question can be finalized and reported back to the requesting system. The checklist may also comprise information regarding expected times for finalizing tasks to be performed, based on measurements of previously performed tasks (by different users) in activities of the same type as the currently performed activity.

Such a process progress indicator may show, in a timeline-like manner, a sequence of activities that have been completed and that have not yet been completed. Based on previous process executions of that same type of process, the graphical user interface may also indicate if the current process is executed faster or slower than what is normal in relation to such previously executed processes.

For instance, when an activity-performing user clicks one of the checklist items of type “Trigger Action”, the user interface may automatically trigger a service call that can push a handover to a secondary system where the actual task needs to be performed.

The system according to the present invention may further comprise a particular subsystem allowing users to design activities or even entire processes, by selecting parameters of the type described above. Such parameters may, for instance, define what specific subsystem to be triggered by said Trigger Action.

For instance, such a configuration subsystem may comprise a user interface allowing users to configure allowed types of requests, and which checklist should be triggered for each request type.

A request type could define basic information such as the title of the request but also the specific checklist and its actions that are to be executed by the user or subsystem responsible for performing the corresponding actions.

The parametric definition of an action of type “Trigger Action”, for instance, may include specific metadata that informs the subsystem receiving the trigger in question about the context and/or intent of this action.

For example, if a defined Trigger Action is “trigger accounting in application X”, the data so that is sent to application X includes a request ID; a task ID; a request data body in turn comprising information being provided by the user in question upfront via said user interface; a requesting user identity (who is asking), and a request type (such as “Accounting”).

As discussed above, said peripheral systems may be of two different types—“controlled” systems designed to communicate bidirectionally with the central system and capable of providing the piece of information resulting from the performance of a particular activity to the central system directly, via an API, and “external” systems, not designed for such bidirectional communication making it necessary to use the mechanism using work product collection as described above.

Hence, a “controlled” system is a system specifically adapted to work together with the central system and whose behaviour is tailored to the central system. Such controlled systems receive information about each request directed to it (request ID) and a particular task that triggered the request (task ID), if this is the case. Controlled systems also receive context about the request (request metadata). This metadata, being structured information specific to the current process context and presented upfront by a requesting entity, allows them to automate more internal actions.

Controlled systems can tell said request portal to update a certain request or a certain activity. They may do so by invoking a corresponding, webservice and passing relevant instructions.

As an example, the checklist item viewed in the request portal of an executing user says “do operation X in system Y”. The user in question will perform this task. Later, when the task has been completed, system Y (which is a controlled system) will automatically call back to the request portal and trigger a “Task(TaskId) is finalized” action with respect to the task in question, and furthermore together with a link to an output of the action (for instance a so new record that was created).

Such controlled systems can create a service request to an external system. To do so, the controlled system will do one of the following:
Pass the request context that it received in the first place. For example, system Y may call upon an external system saying “complete this task”, along with the task ID and request ID received by system Y.
Pass the request with a newly generated request ID that is internally correlated to the original request ID. One example is if system Y issues an invoice with an invoice ID from the context of the original request ID.
Receive non-correlated information from an external system. In this case one of several different cases will occur: An automatic correlation will be conducted, with the aim of finding the above-discussed anchor. If the anchor is found, it will be used to trigger an event stating that the corresponding task has been completed. Using this information, the central system can then subsequently add information to the original process (such as adding completed tasks and/or activities). If no anchor is found, a user of system Y will be invoked to perform a manual correlation in system Y. This manual correlation is then used as a piece of correlation training data for the machine learning module of the central system. Such training of the machine learning module is done by matching unique features of the external system logs and matching them to the internal representation of the task.

The central system may, via the user interface 114, provide user U1 with an overview of process as a work in progress, across different sub systems and activities. The central system may in this capacity extract information from all involved sub systems, and cluster it in a time-sequential manner so as to provide an overview to the user U1.

The central system may also perform process analysis. By aggregating the available information about process development, the central system can calculate average historic times to complete certain activities, and highlight temporal deviations to any checklist of the above-discussed type.

By analysing underlying structured and unstructured information, and using inference based on the parameterized process definition including temporal interdependencies regarding certain activities in the sense that one activity is not possible to perform before another activity, the central system may furthermore determine if certain not explicitly reported events have indeed occurred.

Moreover, by using inferences of this type, the central system may automatically trigger activities in sub systems based on the detection that a certain activity has indeed been completed but not yet explicitly reported back to the central system.

The central system may also comprise a correlation learning module, allowing it to automatically and iteratively modify the process-defining parameters of a particular executed process based on information fed back to the central system regarding actual finalization times for individual activities. For instance, an activity that often results in manual interventions due to poor data quality may take longer time than planned, leading to an automatic change of the process-defining parameter values moving the initiation of that activity to a location earlier during the process.

### Example—Drawdown Notice

1. A Requestor creates a request for a drawdown notice in the Request Portal.
2. An Agent (activity-executing user) performs the first 3 manual steps in the resulting Checklist.
3. The Agent activates action 4 on the checklist which is called “Send to Accounting”. This action invokes a webservice in Netsuite to create an entry that represents the service request.
4. In Netsuite, the Accounting Agent creates the first records associated with the request. Netsuite updates progress on the Checklist.
5. In Netsuite, the Accounting Agent sends a letter to five Investors requesting a transfer. In these letters, each Investor receives a unique Code to use when performing the transfer:
   Two of the Investors disregard the unique code, and prefix the transfer with random characters.
   The other two Investors provide the expected information (the unique Code in question) in the transfer.
6. Netsuite receives the Payment Extracts from the bank:
   Three of the Payment Extracts are automatically matched to the original reference, which allows the central system to update the progress of the activity.
   The other two Payment Extracts cannot be matched. The central system applies the machine learning module to try to guess the matching rule between these two Payment Extracts. None of them is matched the first time. A human Agent is instead invoked to manually reconcile these in Netsuite. This manual reconciliation is used to train the machine learning component to improve future guessings/matchings.
7. As soon as the central system automatically matches the above information, the process status is updated.
8. At a later point in time, a human may be invoked to retroactively and manually verify the reconciliations performed by the system, and the resulting information will be fed back to the machine learning to achieve a possibly corrected set of training data.

Note that the fact that, due to item 7 in the above process scheme, the central system may initiate subsequent process actions even before there is have full certainty of the underlying progress.

As described above, the present method and system achieves integrated centralized visibility over complex processes that cross the boundaries of one single system, using a unified information model. One main finding of the present invention, used to achieve this, is the mechanism described herein for automatically identifying steps in this process that are executed in systems outside the direct control of the central system.

FIG. 7 illustrates the principles behind a watermarking of a request of the type described above, in an example.

A certain Request ID may be a six digit decimal code, of which there may only be less than a few hundred (<=999) available at any given point.

The Request Id is hashed to a fixed length hash.

Then, a Reed-Solomon encoding is applied to generate a watermark that is subsequently handed over to an external system.

The watermark has variable length to “fit” the biggest available space in the external system. For example, if the hash is an eight-digit code and the target external system has place for 16 digits in a free-text field used for the request, a 16-digit watermark will be generated so that the available “loss” (redundancy) can be maximized.

In this and other embodiments, the pre-processing of the second identifier ID2, which may be performed using a Solomon-Reed or any other information-expanding, redundancy-introducing coding algorithm, is such that the second identifier ID2 after pre-processing contains at least 100 bytes of information that is put into the second request R2.

In this and other embodiments, the information contained in the identifier (such as the second identifier ID2) is added to the request (such as in the second request R2) in several respective input fields or areas of the request in question. In other words, the (potentially redundancy-made, encrypted and/or hashed) is split up into at least two distinct parts, each so being added to a respective input field or area in the request in question. Preferably, at least the largest two or more of such parts are of equal byte size±20%. Then, the corresponding collected work product WP will contain the parts of the (possibly processed) identifier in potentially different parts of the work product WP, or only one or some of such parts. The central system 110 is then arranged to analyse, in any of the general ways described herein, the work product WP based on such parts, for instance using the anchor mechanism described herein.

Above, preferred embodiments have been described. However, it is apparent to the skilled person that many modifications can be made to the disclosed embodiments without departing from the basic idea of the invention.

In general, all which has been said regarding the method, the system or the computer software function is equally applicable to the other two of these aspects.

All examples provided are given to illustrate different aspects of the present invention, and are applicable in any combination, as compatible.

Hence, the invention is not limited to the described embodiments, but can be varied within the scope of the enclosed claims.

1. A method for performing a digital process (P), comprising the steps of:
a) providing a central system (110);
b) the central system (110) initiating the process (P) with a defined set of activities (A1;A2) to be performed by respective peripheral systems (210;220) being autonomous systems operating independently from said central system (110), said activities (A1;A2) comprising a second activity (A2) to be performed by a second one of said peripheral systems (220);
c) the central system (110), in a second request (R2), requesting said second peripheral system (220) to perform said second activity (A2);
d) the second peripheral system (220) performing said second activity (A2);
e) a second piece of information (I2) resulting from said second activity (A2) being made available from the second peripheral system (220) to said central system (110); and
f) the central system (110) updating a status of said process (P) based on said second (I2) piece of information,
wherein
the second request (R2) comprises a second identifier (ID2), the second identifier (ID2) comprising redundant information;
the second piece of information (I2) is made available to the central system (110) in the form of a digital work product (WP) output by the second peripheral system (220), and
the central system (110) automatically performs the additional steps of:
g) collecting said work product (WP);
h) finding an anchor piece of information or pattern (I2′) in the work product (WP), the anchor piece of information or pattern (I2′) comprising only a subpart of the second identifier (ID2) and not the entire second identifier (ID2); and
i) identifying said second piece of information (I2) in said work product (WP) based on a content of the anchor piece of information or pattern (I2′).

2. The method of claim 1, wherein
said activities (A1;A2) further comprise a first activity (A1) to be performed by a first peripheral system (210);
wherein the method further comprises the central system (110), in a first request (R1), requesting said first peripheral system (210) to perform said first activity (A1); the first peripheral system (210) performing said first activity (A1); and a first piece of information (I1) resulting from said first activity (A1) being made available from the first peripheral system (210) to said central system (110);
wherein said first piece of information (I1) is automatically made available to the central system (110) using an API (Application Programming Interface) (111,211); and
wherein the central system (110) updates said status of said process (P) based also on said first piece of information (I1).

3. The method of claim 1, wherein the method comprises using an information-expanding, redundancy-producing coding algorithm, such as a Reed-Solomon encoding, to pre-process the second identifier (ID2), so that a resulting alphanumeric string has a predetermined size.

4. The method of claim 1, wherein the pre-processing of the second identifier (ID2) is such that the second identifier (ID2) fits a biggest available space in the second request (R2).

5. The method of claim 4, wherein the pre-processing of the second identifier (ID2) is such that the second identifier (ID2) after pre-processing contains at least 100 bytes of information that is put into the second request (R2).

6. Me The method of claim 1, wherein the second identifier (ID2) comprises or is fully constituted by encrypted information.

7. (canceled)

8. The method of claim 1, wherein said work product (WP) is a log file output by said second peripheral system (220), and wherein the second request (R2) is arranged so that said anchor piece of information or pattern (I2′) will exist in said log file upon activity completion by said second peripheral system (220) of the second activity (A2) as a consequence of the second activity (A2).

9. The method of claim 1, wherein the second identifier (ID2) comprises encrypted information.

10. (canceled)

11. The method of claim 1, wherein the second identifier (ID2) comprises a checksum (CS) of other information comprised in the second identifier (ID2).

12. The method of claim 1, wherein the finding of the anchor piece of information or pattern (I2′) and/or identifying of the second piece of information (I2) is performed by a trained machine learning model (112) comprised in the central system (110).

13. The method of claim 12, wherein a successful finding and/or identifying results in a fully automatic extraction of said second piece of information (I2) from the work product (WP) by the central system (110).

14. The method of claim 13, wherein an unsuccessful interpretation results in an at least partly manual interpretation of said work product (WP), a result of said interpretation being fed back to a machine learning training feedback loop affecting training of said machine learning model (112) with respect to said finding and/or identifying.

15. The method of claim 1, wherein the second piece of information (I2) has a predetermined format, and in that the central system (110) identifies said second piece of information (I2) as a piece of information having said format and being present in the same work product (WP) that also comprises said anchor piece of information or pattern (I2′).

16. The method of claim 1, wherein step e) comprises the central system (110) checking a predetermined information storage area (221) for updates, and in that the central system (110) identifies said work product (WP) in said storage area (221) and reads said work product (WP) from said storage area (221).

17. The method of claim 1, wherein step e) comprises a plurality of work products being provided to the central system (110), in that the central system (110) identifies one particular work product (WP) among said plurality of work products, and in that the central system (110) finds said anchor piece of information or pattern (I2′) in said particular work product (WP).

18. The method of claim 1, wherein the central system (110) comprises or communicates with a central database (113), in turn storing said second identifier (ID2).

19. The method of claim 18, wherein at least one standardized activity is defined by respective values of a predetermined set of activity-defining parameters, in that said database (113) further comprises said activity-defining parameter values, and in that the central system (110) requests at least one activity (A1;A2) based on said activity-defining parameter values.

20. The method of claim 19 wherein the process (P) is a standardized process defined by respective values of a predetermined set of process-defining parameters, in that said database (113) further comprises said process-defining parameter values, and in that the central system (110) automatically identifies and executes said activities based on said process-defining parameter values.

21-26. (canceled)

27. The method of claim 1, further comprising the steps of:
j) said second (220) peripheral system, as a result of said second request (R2), requesting, in a fifth request (R5), a third peripheral system (230) to perform a delta activity (A5), said fifth request (R1) comprising said second (ID2) identifier;
k) said third peripheral system (230) performing said delta activity (A5); and
l) a fifth piece of information (I5) resulting from said delta activity (A5) being made available from the third peripheral system (230) to said requesting peripheral system (210;220).

28. A system (100) for performing a digital process (P), which system (100) comprises a central system (110),
said central system (110) being arranged to initiate the process (P) with a defined set of activities (A1;A2) to be performed by respective peripheral systems (210;220) being autonomous systems operating independently from said central system (110), said activities (A1;A2) comprising a second activity (A2) to be performed by a second one of said peripheral systems (220);
said central system (110) being arranged to, in a second request (R2), request said second peripheral system (220) to perform said second activity (A2),
said central system (110) being arranged to collect a second piece of information (I2) resulting from said second activity (A2) and made available from the second peripheral system (220) to said central system (110), and
said central system (110) being arranged to update a status of said process (P) based on said second (I2) piece of information,
wherein
the second request (R2) comprises a second identifier (ID2), the second identifier (ID2) comprising redundant information,
the central system (110) is arranged to collect said second piece of information (I2) in the form of a digital work product (WP) output by the second peripheral system (220), and
the central system (110) is further arranged to automatically collect said work product (WP); to find an anchor piece of information or pattern (I2′) in the work product (WP), the anchor piece of information or pattern (I2′) comprising only a subpart of the second identifier (ID2) and not the entire second identifier (ID2); and to identify said second piece of information (I2) in said work product (WP) based on a content of the anchor piece of information or pattern (I2′).
